(19) United States
(12) Patent Application Publication
(10) Pub. No.: US 2015/0091681 A1
(43) Pub. Date: Apr. 2, 2015

(54) PERMANENT MAGNETIC COUPLING DEVICE

(71) Applicant: Delta Electronics (Shanghai) Co., Ltd., Shanghai (CN)

(72) Inventors: Hong-Liu ZHU, Shanghai (CN); Tsu-Hua AI, Shanghai (CN); Hong-Cheng SHEU, Shanghai (CN)

(21) Appl. No.: 14/460,870

(22) Filed: Aug. 15, 2014

(30) Foreign Application Priority Data
Sep. 30, 2013 (CN) 201310461605.6

(51) Int. Cl. H01F 7/02

(52) U.S. Cl. CPC H01F 7/0242; H01F 7/021
USPC 335/306

(57) ABSTRACT

A permanent magnetic coupling device includes an conductor rotor, an permanent magnet rotor and permanent magnets. The permanent magnet rotor includes a magnetic ring. The magnetic ring includes protrusions and recesses arranged alternately, in which first airflow channels are formed between the protrusions and the conductor rotor respectively, and second airflow channels are formed between the recesses and the conductor rotor respectively. A cross-sectional area of each of the second airflow channels is greater than a cross-sectional area of each of the first airflow channels. The permanent magnet rotor further includes cavities disposed at the recesses, and the permanent magnets are engaged into the cavities respectively.

### RELATED APPLICATIONS

This application claims priority to China Application Serial Number 201310461605.6, filed Sep. 30, 2013, which is herein incorporated by reference.

### BACKGROUND

1. Field of Invention

The present invention relates to a permanent magnetic coupling device. More particularly, the present invention relates to a permanent magnetic coupling device with wider airflow channels.

2. Description of Related Art

A permanent magnetic coupling device is a transmission device that transmits torque through an air gap. The permanent magnetic coupling device includes an conductor rotor and an permanent magnet rotor. The conductor rotor is fixed on an active shaft and connected to a motor. The permanent magnet rotor is fixed on a load shaft and connected to a load. An air gap is formed between the conductor rotor and the permanent magnet rotor, such that a connection between the motor and the load can be changed from a mechanical connection to a magnetic connection. By controlling the length or area of the air gap between the permanent magnet rotor and the conductor rotor, the output torque of the load shaft can be changed and thereby the rotational speed of the load can be adjusted.

The permanent magnetic coupling device has the following advantages on actual applications: the drive motor can be actuated with no load, so that the initial current of the motor is decreased, thus prolonging the motor operation life and reducing the effects on a power system; because the torque is transmitted through the air gap, the connection accuracy required between the motor and the load is lowered, and the mechanical vibration and noise are reduced; adopting the permanent magnetic coupling device can achieve the continuous adjustment of flow or pressure, and thus is more energy-saving smaller than adopting a valve or damper.

However, the slip power of the permanent magnetic coupling device is consumed on the conductor rotor. Therefore, the greater the power of the permanent magnetic coupling device is, the higher the temperature of the conductor rotor is. Once the temperature of the conductor rotor is transmitted to the permanent magnet rotor, permanent demagnetization may occur on permanent magnets of the permanent magnet rotor, thus causing malfunctioning of the permanent magnetic coupling device.

One solution of the conventional techniques is to dispose heat dissipation blades on a surface of outer edge of the conductor rotor to improve heat dissipation capability. When the conductor rotor rotates, the heat dissipation blades can induce air flow to perform thermal dissipation. However, this solution will increase the noise of the heat dissipation blades. Moreover, when a full load operation is performed, because the air gap is narrow to result in high wind resistance, the air flow induced by the heat dissipation blades gets weaker, thus restricting heat dissipation capability. As to the cylindrical permanent magnetic coupling device, the air gap is at the narrowest statues during the entire rotational speed adjustment process, and heat dissipation capability is extremely restricted.

Another solution of the conventional techniques is to adopt a method of water cooling to lower the temperature of the conductor rotor. The cooling water that enters into the rotating conductor rotor has to be connected to a rotary connector. The rotary connector includes an axle and an envelope, and a bearing is disposed between the axle and the envelope, such that the axle and the envelope may rotate relative to each other. According to operation states, the axle and the envelope each may act as a stator or a rotor, in which the stator and the rotating conductor rotor are in a coaxial rotation. An oil port of the stator is connected to a fixed pipe conveying liquid, and an oil port of the rotor is connected to the pipe of the conductor rotor. In order to prevent the cooling water from leaking out of between the stator and the rotor, a sealing ring is disposed between the stator and the rotor. Because the sealing ring needs to replaced yearly, the maintenance cost is also high.

### SUMMARY

The present invention provides a permanent magnetic coupling device which has a greater airflow channel to improve heat dissipation capability of the permanent magnetic coupling device.

An aspect of the present invention is to provide a permanent magnetic coupling device including an conductor rotor, an permanent magnet rotor, and permanent magnets. The permanent magnet rotor includes a magnetic ring. The magnetic ring includes protrusions and recesses arranged alternately, in which first airflow channels are formed between the protrusions and the conductor rotor respectively and second airflow channels are formed between the recesses and the conductor rotor respectively. A cross-sectional area of each of the second airflow channels is greater than a cross-sectional area of each of the first airflow channels. The permanent magnet rotor further includes cavities disposed at the recesses, and the permanent magnets are engaged into the cavities respectively.

The first airflow channels and the second airflow channels are disposed between the permanent magnet rotor and the conductor rotor of the permanent magnetic coupling device, in which the cross-sectional area of each of the second airflow channels is greater than the cross-sectional area of each of the first airflow channels. Therefore, the amount of air flow is increased, and the heat dissipation capability of the permanent magnetic coupling device is also improved. Meanwhile, the power is mainly consumed by the conductor ring of the conductor rotor. Because the permanent magnets disposed at the recesses are spaced away from the conductor ring, the temperature rise of the permanent magnets is decreased, such that the probability of the demagnetization of the permanent magnets is reduced. In addition, in the aspect of manufacture, the fixation way of engaging the permanent magnets into the cavities is more convenient than the conventional method of adhering the permanent magnets to a surface of the magnetic ring.

### BRIEF DESCRIPTION OF THE DRAWINGS

The invention can be more fully understood by reading the following detailed description of the embodiment, with reference made to the accompanying drawings as follows:

FIG. 1 is a schematic cross-sectional diagram of a permanent magnetic coupling device according to a first embodiment of the present invention;

FIG. 2 is a schematic 3D diagram of a permanent magnet rotor as illustrated in FIG. 1;

FIG. 3 is a schematic diagram of magnetic polarity and magnetic field lines of permanent magnets as illustrated in FIG. 1;

FIG. 4 is a schematic diagram showing a fixation method for an aluminum ring in FIG. 3;

FIG. 5 is a schematic diagram showing another fixation method for an aluminum ring in FIG. 3;

FIG. 6 is a schematic cross-sectional view of a permanent magnetic rotor according to a second embodiment of the present invention;

FIG. 7 is a schematic 3D diagram of a permanent magnetic rotor according to a third embodiment of the present invention;

FIG. 8 is a schematic 3D diagram of a permanent magnetic rotor according to a fourth embodiment of the present invention;

FIG. 9 is a schematic 3D diagram of a permanent magnetic rotor according to a fifth embodiment of the present invention; and

FIG. 10 is a schematic assembly drawing of a permanent magnet rotor in FIG. 8.

### DETAILED DESCRIPTION

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations.

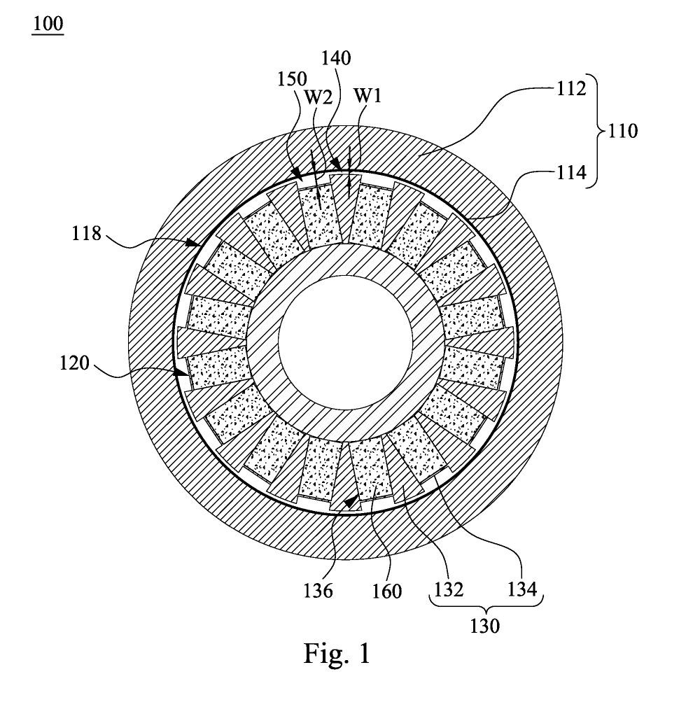

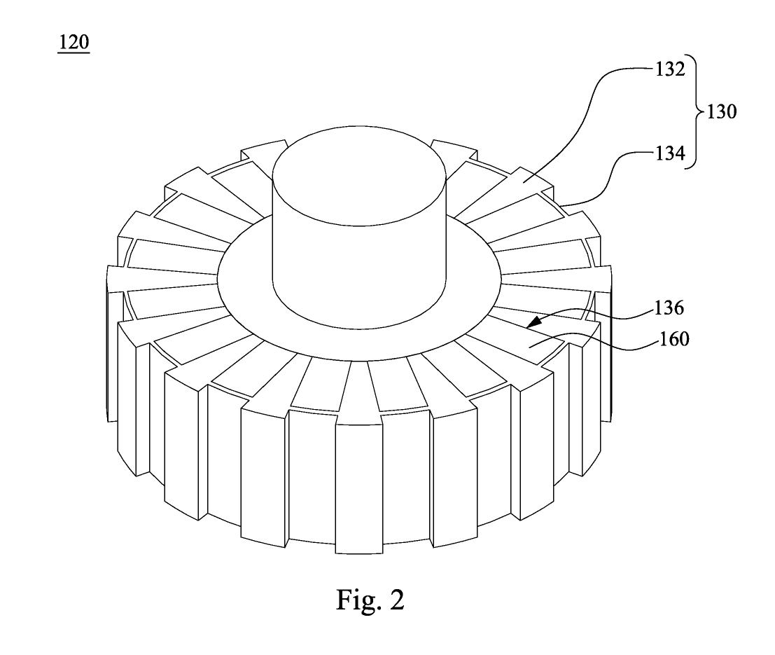

According to FIG. 1 and FIG. 2, FIG. 1 is a schematic cross-sectional diagram of a permanent magnetic coupling device 100 according to a first embodiment of the present invention, and FIG. 2 is a schematic 3D diagram of a permanent magnet rotor in FIG. 1. The permanent magnetic coupling device 100 includes a conductor rotor 110 and a permanent magnet rotor 120, in which the permanent magnet rotor 120 includes a magnetic ring 130. The magnetic ring 130 includes protrusions 132 and recesses 134 arranged alternately. First airflow channels 140 are formed between the protrusions 132 and the conductor rotor 110 respectively, and second airflow channels 150 are formed between the recesses 134 and the conductor rotor 110 respectively. A cross-sectional area of each of the second airflow channels 150 is greater than a cross-sectional area of each of the first airflow channels 140. A width of the each of the first airflow channels 140 W1 is in a range from 2 mm to 8 mm, and a width of the each of the second airflow channels 150 W2 is in a range from 6 mm to 20 mm. The first airflow channels 140 and the second airflow channels 150 are parallel to an axis of the permanent magnet rotor 120.

The permanent magnet rotor 120 further includes cavities 136 disposed at the recesses 134. The permanent magnetic coupling device 100 further includes permanent magnets 160 engaged into the cavities 136 respectively. The magnetic ring 130 is made of low carbon steel or a silicon steel plate, and the permanent magnets 160 are made of a permanent material, such as Nd—Fe—B. The permanent magnets 160 are engaged into the cavities 136 one-to-one. The permanent magnets 160 are disposed at the recesses 134 of the magnetic ring 130 and between the protrusions 132. The second airflow channels 150 are disposed between the recesses 134 and the conductor rotor 110.

The conductor rotor 110 includes a magnetic cylinder 112 and a conductor ring 114. The conductor 114 is disposed on an inner surface of the magnetic cylinder 112. The magnetic cylinder 112 is made of low carbon steel or a silicon steel plate, and the conductor ring 114 is made of copper or aluminum.

Because the cross-sectional area of the second airflow channels 150 is greater the cross-sectional area of the first airflow channels 140, the amount of air flow is increased such that heat dissipation capability is improved. Meanwhile, the power is mainly consumed by the conductor ring 114 of the conductor rotor 110. Because the permanent magnets 160 disposed at the recesses 134 is spaced away from the conductor ring 114, the temperature rise of the permanent magnets 160 is decreased. Therefore, the probability of the demagnetization of the permanent magnets 160 is reduced. In addition, in the aspect of manufacture, the fixation of engaging the permanent magnets 160 into the cavities 136 is more convenient than the conventional method of adhering the permanent magnets 160 to a surface of the magnetic ring 130.

The permanent magnetic coupling device 100 of the present embodiment can be a cylindrical type permanent magnetic coupling device. The conductor rotor 110 has an accommodation cavity 118, and the permanent magnet rotor 120 is disposed in the accommodation cavity 118. However, the design of the permanent magnet rotor 120 with the alternately disposed protrusions and recesses or the fixation method of engaging the permanent magnets 160 into the cavities 136 described in the present embodiment also can be applied to a plate type permanent magnetic coupling device, and the details are not described again herein.

In a 300 kW permanent magnetic coupling device, an air gap width of a conventional permanent magnetic coupling device is 4 mm, and an air gap area is 0.005 m². When a rotation speed of a permanent magnet rotor is 120 rpm, an average wind velocity is 0.30 m/s. After the structure of the present embodiment is applied, the surface of the permanent magnet rotor 120 is added with second airflow channels 150 each having a greater cross-sectional area. A width of the second airflow channel 150 is 13.25 mm, and the total air gap area is 0.011 m², and an axial average wind velocity is 0.60 m/s which is doubled from the conventional one. It can be known from the above that, the design of the present embodiment not only can increase the total air gap area to improve the heat dissipation capability but also can increase the axial average wind velocity.

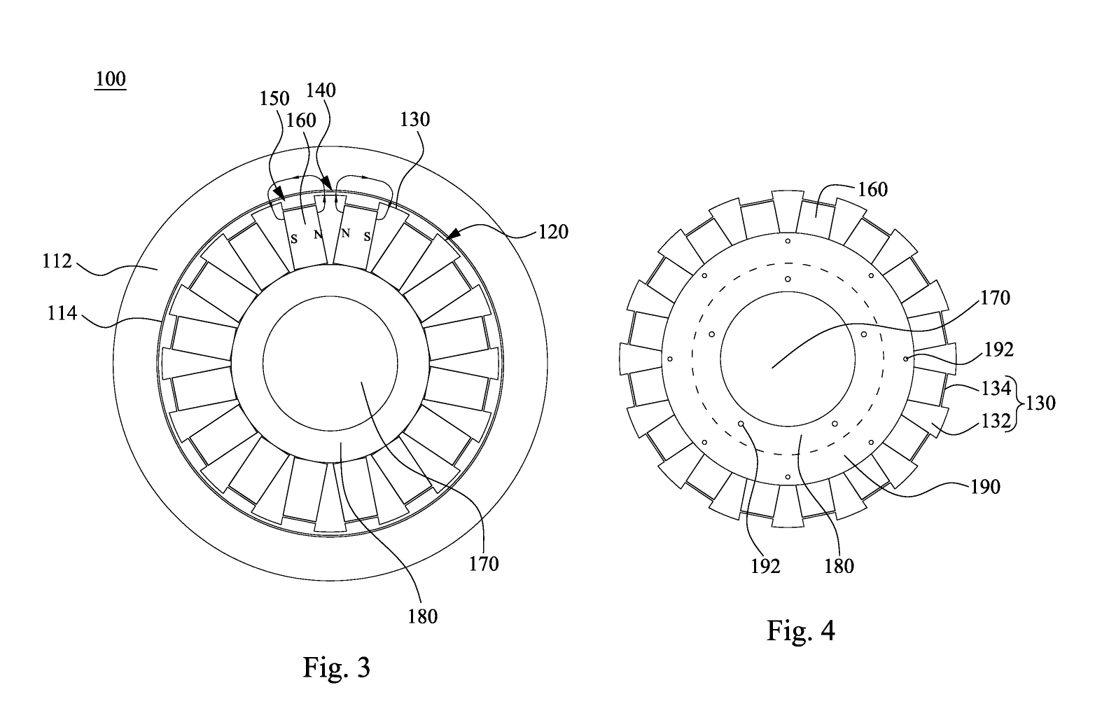

FIG. 3 is a schematic diagram of magnetic polarity and magnetic field lines of permanent magnets 160 as illustrated in FIG. 1. According to the FIG. 3, each of the permanent magnets 160 includes a N-type magnetic pole and a S-type magnetic pole. A magnetic field line travels from the N-type magnetic pole through the magnetic ring 130, the first airflow channel 140 and the conductor ring 114, and reaches the magnetic cylinder 112. Then, the magnetic field line travels from the magnetic cylinder 112 through the conductor ring 114 and the first airflow channel 140, and reaches the magnetic ring 130. Finally, the magnetic field line returns back to the S-type magnetic pole of the permanent magnets 160, so as to form a loop. The magnetic poles of two adjacent permanent magnets 160 facing each other are the same. For instance, the N-type magnetic pole of a permanent magnet and the N-type magnetic pole of another permanent magnet are face to face. In other words, the two permanent magnets 160 on both sides of one protrusion (as shown in FIG. 1) of the magnet ring 130 have the same-polarity magnetic poles.

The permanent magnet rotor 120 includes a load shaft 170 connected to a load end. In order to prevent the magnetic field lines of the permanent magnets 160 from passing through the load shaft 170, the permanent magnetic coupling device 100 further includes an aluminum ring 180. The aluminum ring 180 is fixed on the load shaft 170, and disposed between the load shaft 170 and the magnetic ring 130 in order to prevent magnetic leakage of the magnetic field lines of the permanent magnets 160 from occurring at the load shaft 170.

FIG. 4 is a schematic diagram showing a fixation method for the aluminum ring 180 in FIG. 3. The permanent magnetic coupling device 100 further includes a fastener 190 and screws 192. The magnetic ring 130 and the aluminum ring 180 have screw holes respectively, and the fastener 190 has openings corresponding to the screw holes. Each of the screw 192 passing through each of the openings of the fastener 190 is secured in each of the screw hole of the magnetic ring 130 and with the aluminum ring 180 respectively. Therefore, the magnetic ring 130 and the fastener 190, the fastener 190 and aluminum ring 180 are secured by the screws 192, such that the aluminum ring 180 is fixed on the load shaft 170.

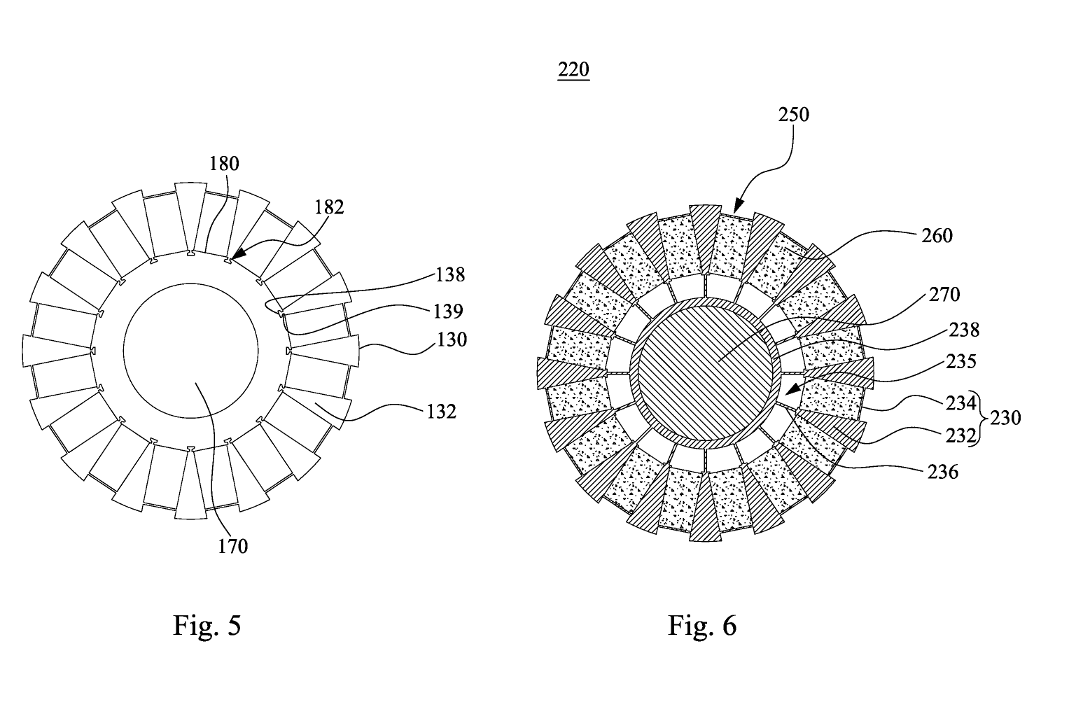

FIG. 5 is a schematic diagram showing another fixation method for the aluminum ring 180 in FIG. 3. In addition to the fixation method shown in FIG. 4 for securing the aluminum ring 180 by the fastener 190 and the screws 192, the aluminum ring 180 also can be secured by a structural design according to the present embodiment. For example, the magnetic ring 130 includes bumps 138, the aluminum ring 180 includes grooves 182, and the bumps 138 are engaged in the grooves 182 to fix the magnetic ring 130 on the aluminum ring 180.

In particular, the aluminum ring 180 can be fixed on the load shaft 170. The bumps 138 of the magnetic ring 130 are disposed on opposite sides of the protrusions 132, and each of the bumps 138 includes a neck portion 139 shrinking inwards. The shapes of the grooves 182 and the bumps 138 match with each other, such that the bumps 138 and the grooves 182 can be secured firmly, thereby connecting the aluminum ring 180 and the magnetic ring 130.

FIG. 6 is a cross-sectional schematic view of a permanent magnetic rotor according to a second embodiment of the present invention. A permanent magnet rotor 220 includes a magnetic ring 230 including protrusions 232 and recesses 234 which are arranged alternately. First airflow channels are formed between the protrusions 232 and the conductor rotor (refer to the FIG. 1) respectively, and second airflow channels 250 are formed between the recesses 234 and the conductor rotor respectively. A cross-sectional area of each of the second airflow channels 250 is greater than a cross-sectional area of each of the first airflow channels.

The magnetic ring 230 connects to a load shaft 270. The magnetic ring 230 further includes magnetic bridges 236 disposed between the load shaft 270 and the protrusions 232. The magnetic ring 230 further includes a magnetic inner ring 238 fixed on the load shaft 270. The magnetic inner ring 238 and the protrusions 232 are connected through the magnetic bridges 236 such that cavities 235 are formed between the magnetic bridges 236, in which the cavities 235 are disposed between permanent magnets 260 and the magnetic inner ring 238.

The present embodiment can prevent the magnetic field lines of the permanent magnets 260 from flowing out the load shaft 270 by the magnetic bridges 236. Moreover, the aluminum ring 180 in FIG. 3 to FIG. 5 can be omitted.

The permanent magnetic coupling device of the present invention can increase air pressure of the permanent magnet rotor by adjusting an angle between the first airflow channel or the second airflow channel and the axial direction of the load shaft, thereby improving the heat dissipation capability. Hereinafter, the detailed description is explained with the embodiments.

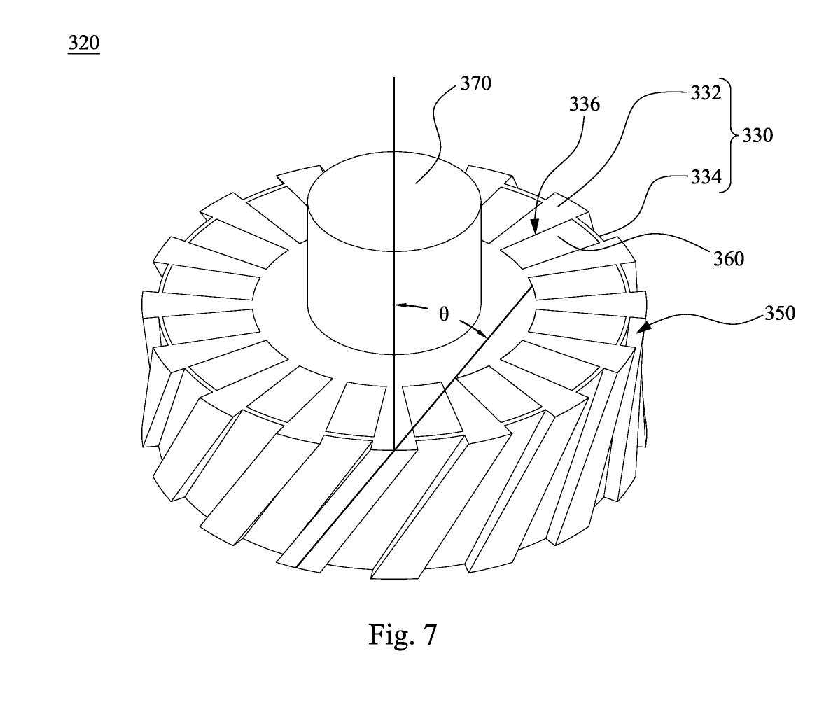

FIG. 7 is a schematic 3D diagram of a permanent magnetic rotor according to a third embodiment of the present invention. A permanent magnet rotor 320 includes a magnetic ring 330, and the magnetic ring 330 includes protrusions 332 and recesses 334 arranged alternately. First airflow channels are formed between the protrusions 332 and the conductor rotor (referring to FIG. 1), and second airflow channels 350 are formed between the recesses 334 and the conductor rotor. A cross-sectional area of each of the second airflow channels 350 is greater than a cross-sectional area of each of the first airflow channels. Permanent magnets 360 are engaged in cavities 336 disposed in the recesses 334.

In the present embodiment, the protrusions 332 and the recesses 334 are approximately parallel to each other. An angle θ is defined between the protrusions 332, the recesses 334 or the second airflow channel 350 and an axial direction of the permanent magnet rotor 320. The angle θ is from 0 to 240/p degrees, in which p is a number of the magnetic pole pairs. For example, if the permanent magnets 360 arranged is 10, the number of the magnets is 10, the number of the magnetic pole pairs is 5, and the angle θ is from 0 degrees to 48 degrees.

In the present embodiment, the shape of the permanent magnets 360 is a distorted rectangular block. Therefore, each of the permanent magnets 360 can be formed from two bonded magnet steels of specific shapes and a sintering magnetic steel with oblique prisms.

Such design of the oblique arrangement of the protrusions 332, the recesses 334, and the second airflow channel 350 with the axial direction of the permanent magnet rotor 320 can further enhance wind pressure of the permanent magnet rotor 320. In the 300 kW permanent magnetic coupling device, the width of the air gap of the conventional permanent magnetic coupling device is 4 mm, and the area of the air gap is 0.005 m². When the rotational speed of the permanent magnet rotor is 120 rpm, the average wind velocity is 0.30 m/s. After the structure of the present embodiment is applied, if the second airflow channel 350 slants to the axial direction of the permanent magnet rotor 320 with 10.8 degrees, in which the angle θ is 10.5 degrees, the average wind velocity is 0.93 m/s which is enhanced by 3.1 times.

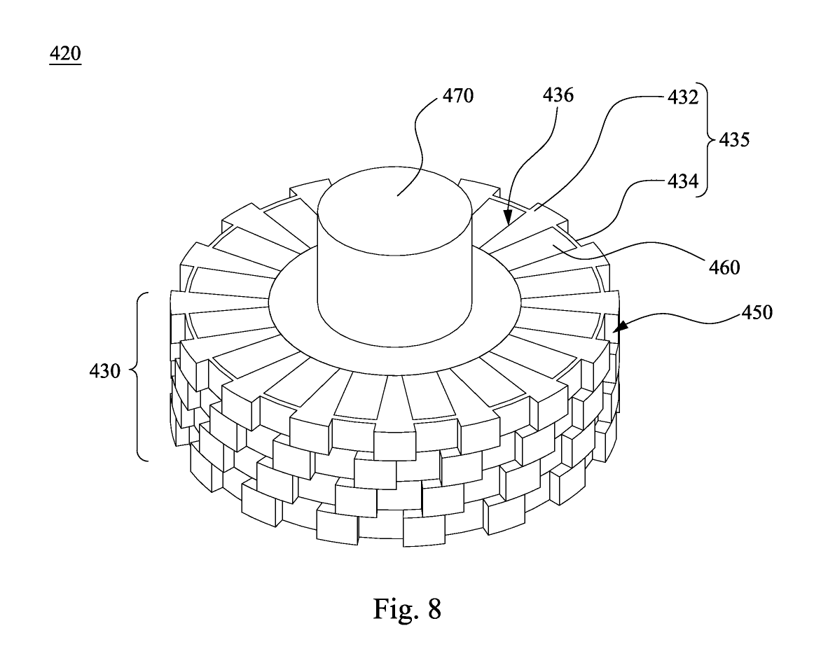

FIG. 8 is a schematic 3D diagram of a permanent magnetic rotor according to a fourth embodiment of the present invention. A magnetic ring 430 of a permanent magnet rotor 420 includes stacked circular magnetic sheets 435, and each of the circular magnetic sheets 435 includes protrusions 432 and recesses 434 arranged alternately. First airflow channels are formed between the protrusions 432 and the conductor rotor (referring to FIG. 1), second airflow channels 450 are formed between the recesses 434 and the conductor rotor. A cross-sectional area of each of the second airflow channels 450 is greater than a cross-sectional area of each of the first airflow channels. Permanent magnets 460 are engaged in cavities 436 disposed in the recesses 434 respectively.

The adjacent circular magnetic sheets 435 are spaced by a fixed angle. This fixed angle is from 0 degrees to 240/p degrees, in which p is a number of the magnetic pole pairs. Taking the permanent magnet rotor 420 of FIG. 8 as an example, the fixed angle is 3 degrees between any two adjacent circular magnetic sheets 435, and thus in any two adjacent circular magnetic sheets 435, the bottom one is deviated from the upper one by 3 degrees. Consequently, the second airflow channels 450 slant to a load shaft 470, and the wind pressure is enhanced as well.

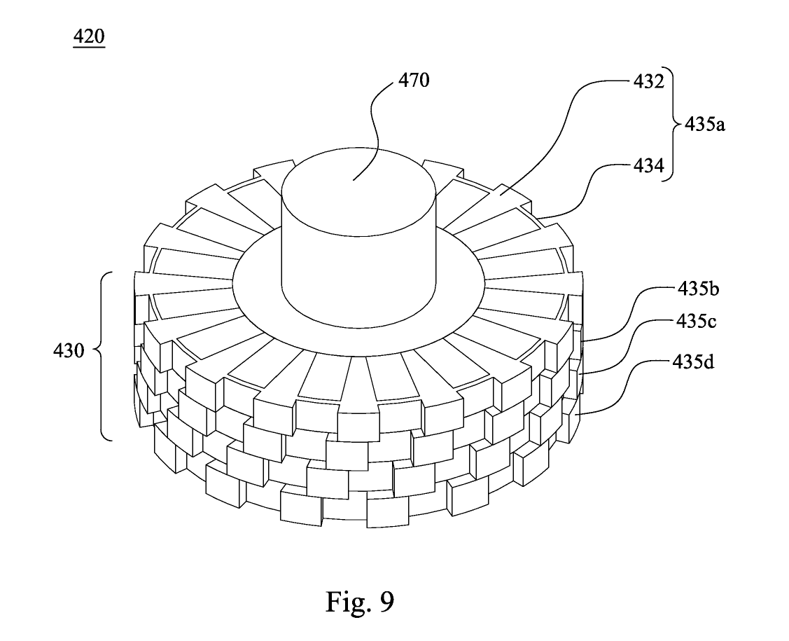

FIG. 9 is a schematic 3D diagram of a permanent magnetic rotor according to a fifth embodiment of the present invention. A magnetic ring 430 of a permanent magnet rotor 420 includes stacked circular magnetic sheets 435a-d, and each of the circular magnetic sheets 435a-d includes protrusions 432 and recesses 434 arranged alternately. A difference between the present embodiment and the fourth embodiment is that the adjacent circular magnetic sheets 435a-d are spaced by a predetermined angle, and this predetermined angle gradually increases or decreases from one end to the other end of the magnetic ring 430. The predetermined angle is from 0 degrees to 240/p degrees, in which p is a number of the magnetic pole pairs. Taking the permanent magnet rotor 420 in FIG. 9 as an example, there are four circular magnetic sheets 435a-d. The predetermined angle between the circular magnetic sheet 435a and the circular magnetic sheet 435b is 3 degrees. The predetermined angle between the circular magnetic sheet 435b and the circular magnetic sheet 435c is 4 degrees. The predetermined angle between the circular magnetic sheet 435c and the circular magnetic sheet 435d is 5 degrees. Such disposition provides an appearance similar to a fan, thereby further enhancing the wind pressure.

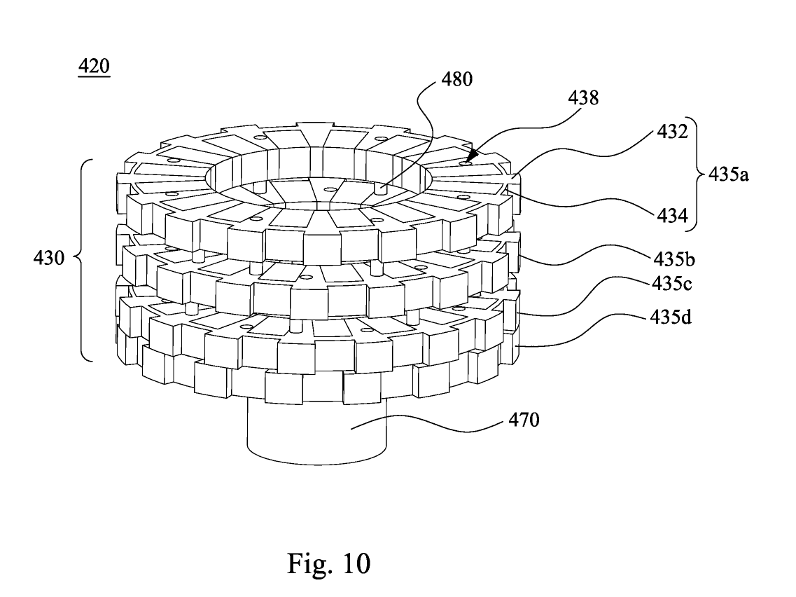

FIG. 10 is a schematic assembly drawing of a permanent magnet rotor in FIG. 8. Each of the circular magnetic sheets 435a-d includes through holes 438 disposed at the protrusions 432, and the permanent magnet rotor 420 further includes positioning pillars 480. The positioning pillars 480 pass through the through holes 438 of the adjacent circular magnetic sheets 435a-d such that a magnetic ring 430 is built of the circular magnetic sheets 435a-d.

Assumed that a height of each of circular magnetic sheets 435a-d is H and a height of each of the positioning pillars is h, and then the relationship between H and h is H<h<2H. In other words, the height of each of the positioning pillars 480 is greater than the height of the circular magnetic sheet 435a-d and less than twice the height of the circular magnetic sheet 435a-d. FIG. 10 shows four circular sheets 435a-d arranged alternately, any two of the adjacent circular magnetic sheets 435a-d are connected and fixed by inserting eight positioning pillars 480 there between. Correspondingly, the circular magnetic sheet 435a and the circular magnetic sheet 435d are bored with eight through holes 438, and the circular magnetic sheet 435b and the circular magnetic sheet 435c are bored with sixteen through holes 438. When being assembled, at first, the circular magnetic sheet 435d and the load shaft 470 are assembled, and then the permanent magnets 460 and the positioning pillars 480 are inserted. Thereafter, the circular magnetic sheet 435c is assembled, and the permanent magnets 460 and the positioning pillars 480 are inserted in the same way. The rest may be deduced by analogy until the last circular magnetic sheet (the circular magnetic sheet 435a in the FIG. 10 or the upmost sheet) and the permanent magnets 460 are assembled. This fabrication method can achieve the assembly with the fixed angles or the predetermined angles between the circular magnetic sheets 435a-d easily and accurately.

The first airflow channels and the second airflow channels are disposed between the permanent magnet rotor and the conductor rotor of the permanent magnetic coupling device, in which the cross-sectional area of each of the second airflow channels is greater than the cross-sectional area of each of the first airflow channels. Therefore, the amount of air flow is increased, and the heat dissipation capability of the permanent magnetic coupling device is improved as well. Meanwhile, the power is mainly consumed at the conductor ring of the conductor rotor. Because the permanent magnets disposed at the recesses is away from the conductor ring, the temperature rise of the permanent magnets is decreased. Therefore, the probability of the demagnetization of the permanent magnets is reduced. In addition, in the aspect of manufacture, the fixation method of engaging the permanent magnets into the cavities is more convenient than conventional method of adhering the permanent magnets on a surface of the magnetic ring.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A permanent magnetic coupling device, comprising
a conductor rotor;
a permanent magnet rotor, comprising:
a magnetic ring comprising a plurality of protrusions and a plurality of recesses arranged alternately, wherein first airflow channels are formed between the protrusions and the conductor rotor respectively, second airflow channels are formed between the recesses and the conductor rotor respectively, and a cross-sectional area of each of the second airflow channels is greater than a cross-sectional area of each of the first airflow channels; and
a plurality of permanent magnets disposed in a plurality of cavities of the recesses, wherein the permanent magnets are engaged into the cavities respectively.

2. The permanent magnetic coupling device of claim 1, wherein the conductor rotor comprises an accommodation cavity, and the permanent magnet rotor is disposed in the accommodation cavity.

3. The permanent magnetic coupling device of claim 1, wherein the first airflow channels and the second airflow channels are parallel to an axis of the permanent magnet rotor.

4. The permanent magnetic coupling device of claim 1, wherein the magnetic ring is made of low carbon steel or a silicon steel plate, and the permanent magnets are made of a permanent material of Nd—Fe—B.

5. The permanent magnetic coupling device of claim 1, wherein the conductor rotor comprises a magnetic cylinder and a conductor ring, the conductor ring is disposed on an inner surface of the magnetic cylinder, wherein the first airflow channels are disposed between the protrusions and the conductor rotor, and the second airflow channels are disposed between the recesses and the conductor rotor.

6. The permanent magnetic coupling device of claim 5, wherein the magnetic cylinder is made of low carbon steel or a silicon steel plate, and the conductor ring is made of copper or aluminum.

7. The permanent magnetic coupling device of claim 1, wherein the two permanent magnets on both sides of one protrusion of the magnet ring have the same-polarity magnetic poles.

8. The permanent magnetic coupling device of claim 7, wherein the magnetic pole of the two permanent magnets is a N-type magnetic pole.

9. The permanent magnetic coupling device of claim 7, wherein the magnetic pole of the two permanent magnets is a S-type magnetic pole.

10. The permanent magnetic coupling device of claim 1, wherein an angle is defined between the protrusions and an axis of the permanent magnet rotor, and the angle is from 0 degrees to 240/p degrees, where p is a number of the magnetic pole pairs.

11. The permanent magnetic coupling device of claim 1, wherein the permanent magnet rotor comprises a load shaft and an aluminum ring, and the aluminum ring is fixed on the load shaft and disposed between the load shaft and the magnetic ring.

12. The permanent magnetic coupling device of claim 11, wherein the aluminum ring comprises a plurality of grooves, and the magnetic ring comprises a plurality of bumps, and the bumps are engaged in the grooves so as to fix the magnetic ring on the aluminum ring.

13. The permanent magnetic coupling device of claim 12, wherein the bumps are disposed on opposite sides of each of the protrusions, and each of the bumps has a neck portion, and shapes of the grooves match shapes of the bumps.

14. The permanent magnetic coupling device of claim 11, further comprising a fastener and a plurality of screws, wherein each screw passes through an opening of the fastener and is locked into a screw hole of the magnetic ring so as to secure the fastener and the magnetic ring.

15. The permanent magnetic coupling device of claim 11, further comprising a fastener and a plurality of screws, wherein each screw passes through an opening of the fastener and is locked into a screw hole of the aluminum ring so as to secure the fastener and the aluminum ring.

16. The permanent magnetic coupling device of claim 1, further comprising a load shaft connected to the magnetic ring, wherein the magnetic ring comprises a plurality of magnetic bridges corresponding to the protrusions, and the magnetic bridges are disposed between the load shaft and the protrusions.

17. The permanent magnetic coupling device of claim 1, wherein the magnetic ring comprises a plurality of stacked circular magnetic sheets, and each of the circular magnetic sheets has the protrusions and the recesses.

18. The permanent magnetic coupling device of claim 17, wherein the adjacent circular magnetic sheets are spaced by a fixed angle.

19. The permanent magnetic coupling device of claim 17, wherein the adjacent circular magnetic sheets are spaced by a predetermined angle, and the predetermined angle gradually increases or decreases from one end to the other end of the magnetic ring.

20. The permanent magnetic coupling device of claim 17, wherein each of the circular magnetic sheets comprises a plurality of through holes disposed at the protrusions, and the permanent magnet rotor further comprises a plurality of positioning pillars, and the positioning pillars pass through the adjacent through holes of the circular magnetic sheets to form the magnetic ring.

21. The permanent magnetic coupling device of claim 20, wherein the height of the positioning pillar is greater than the height of the circular magnetic sheet and less than twice the height of the circular magnetic sheet.

22. The permanent magnetic coupling device of claim 1, wherein the first airflow channel has a width in a range from 2 mm to 8 mm, and the second airflow channel has a width in a range from 6 mm to 20 mm.

23. The permanent magnetic coupling device of claim 1, wherein the permanent magnetic coupling device is a plate type or a cylindrical type.
